(19) United States
(12) Patent Application Publication
(10) Pub. No.: US 2010/0262598 A1
(43) Pub. Date: Oct. 14, 2010

(54) USER INTERFACE RECOGNITION DEVICE AND USER INTERFACE RECOGNITION METHOD

(75) Inventors: Kazuya Koyama, Tokyo (JP); Keiichi Iguchi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/742,833

(22) PCT Filed: Nov. 21, 2008
(86) PCT No.: PCT/JP2008/071223

§ 371 Date: May 13, 2010

(30) Foreign Application Priority Data
Nov. 21, 2007 (JP) 2007-302209

(51) Int. Cl. G06F 17/30

(52) U.S. Cl. 707/723; 707/769; 707/797; 707/E17.014; 707/E17.012

(57) ABSTRACT

A search rule generation unit (2502) pregenerates a search rule for searching for a search target part among parts forming a user interface, based on user interface information indicating the parts forming the user interface and the positional relationship between the parts, search target part information indicating the search target part among the parts, and structure definition information defining the structure of the user interface. When new user interface information is input, a part search unit (2503) searches for the search target part among parts indicated by the new user interface information by using the pregenerated search rule. This makes it possible to correctly specify a part in a user interface having an unclear inconstant structure.

### TECHNICAL FIELD

The present invention mainly relates to a user interface recognition system for recognizing the structure of a user interface output by an application and, more particularly, to a user interface recognition device and user interface recognition method capable of recognizing the structure of a user interface even when the display of the user interface has changed.

### BACKGROUND ART

Conventionally, an application (to be referred to as an AP hereinafter) such as a program operating on the World Wide Web (to be referred to as the WWW hereinafter) or on a desktop has directly been operated by a user by a graphical user interface (to be referred to as a GUI hereinafter) initially incorporated in the program of the AP.

Unfortunately, this GUI designed by the developer of an AP is not always suitable for the user. For example, even when it is desirable to record AP operations performed by the user and analyze the user's behavior, the GUI of the AP does not always have a function of outputting the user's GUI operation record as a log. Also, even when the user wants to change the layout of the GUI screen or automate the AP operation in order to meet his or her taste or interest or to meet the difference between user environments, the AP does not always have this changing function or automating function. This is so because the AP developer needs a very large development cost to take account of all these requirements and implement all these functions, and this is unrealistic.

To solve this problem, the functions as described above are often added by an external program to a GUI output by an AP, without correcting the program of the AP itself, by recognizing and controlling the contents of the GUI. In many cases, a GUI output by an AP has only basic GUI parts such as buttons and texts and their layout information. Therefore, to issue an event of recording a log indicating pressed buttons or the like or an event of pressing specific buttons in place of the user to automate the AP operation, an external program as described above performs the process of uniquely identifying each GUI part from the layout information. For example, when the user wants to extract information from a WWW application or automatically operate a WWW application, he or she recognizes a user interface (to be referred to as a UI hereinafter) by using only HTML having only element parts and their layout information, and estimates the meaning of an element part such as a character string or input form. Note that this processing will be called the recognition of a UI in this specification.

Techniques of recognizing a UI output by an AP are as follows.

For example, reference 1 (Japanese Patent Laid-Open No. 2004-240759) has disclosed a method of recognizing a UI by character recognition, image recognition, or the acquisition of the hierarchical structure of parts, in order to obtain the operation log of the UI.

Also, reference 2 (Japanese Patent Laid-Open No. 2001-306358) has disclosed a GUI testing method of recording the logical structures of GUIs, and evaluating test results and determining whether to execute a test, by using the results of comparison between the stored logical structures.

Furthermore, although this is not the recognition of a generated UI, reference 3 (Japanese Patent Laid-Open No. 2007-511814) has disclosed a method of generating a UI program by recognizing the image of a UI written on paper or the like.

### DISCLOSURE OF INVENTION

### Problem to be Solved by the Invention

Unfortunately, the above-described UI recognition techniques have the problem that it is difficult to recognize a UI having an unclear inconstant structure such that parts can correctly be specified.

Generally, the layout of a UI changes due to various factors. For example, even when the contents of a UI remain the same, the layout sometimes changes if an environment in which the application is used changes. Examples of the environment are the type of operating system, the type of WWW browser when the application is used in the WWW, the screen size of the display device of a computer, and the window size of the application when the application is used in the window system. Also, when a UI displays dynamically changing contents, e.g., a WWW page that displays the results of a certain search, the layout may change in accordance with the contents such as the hit count of the search results. Furthermore, the layout changes in some cases in accordance with the change in AP, e.g., the version-up of the program of the AP itself.

As disclosed in reference 1 or reference 2, when the display layout changes in accordance with the environment while the contents remain the same, it is possible to cope with the change by extracting the logical structure between GUI parts such as the parent-child relationship between the parts, and recognizing the UI based on this information. Especially in the WWW, a UI is originally output by a structural document called Hyper Text Markup Language (to be referred to as HTML hereinafter). By analyzing this HTML, therefore, it is possible to interpret the HTML, and recognize the UI independently of the display environment.

If the contents of a UI have changed or the original AP itself has changed, however, the above-mentioned original structure itself changes. This makes it impossible to correctly recognize the UI by simply extracting the logical structure.

Also, reference 4 (Japanese Patent Laid-Open No. 2004-318460) has disclosed a method of achieving tactile control of an inconstant UI. Unfortunately, this method is based on the assumption that an AP provides the structure information of a UI, and inapplicable to an AP that does not output this information.

The invention has been made in consideration of the above situation, and has as its exemplary object to provide a user interface recognition device and user interface recognition method capable of correctly recognizing a UI even when the UI has changed owing to the contents or an AP.

### Means for Solving the Problem

To achieve the above exemplary object, a user interface recognition device of the invention includes a search rule generation unit which generates a search rule for searching for a search target part among parts forming a user interface, based on user interface information indicating the parts forming the user interface and a positional relationship between the parts, search target part information indicating the search target part among the parts, and structure definition information defining a structure of the user interface, a part search unit which, when new user interface information is input, searches for the search target part among parts indicated by the new user interface information by using the search rule generated by the search rule generation unit, and an output unit which outputs a search result from the part search unit.

Also, a user interface recognition method of the invention includes the steps of generating a search rule for searching for a search target part among parts forming a user interface, based on user interface information indicating the parts forming the user interface and a positional relationship between the parts, search target part information indicating the search target part among the parts, and structure definition information defining a structure of the user interface, searching for, when new user interface information is input, the search target part among parts indicated by the new user interface information by using the search rule, and outputting a search result.

### EFFECTS OF THE INVENTION

The invention can specify a UI part corresponding to the change in UI caused by the change in contents of an AP. This is so because the invention can recognize the change in UI caused by the change in contents as structure definition information, and form a part search rule by using the information, thereby performing search by taking account of the change in structure caused by the change in contents.

### BRIEF DESCRIPTION OF DRAWINGS

FIG. 1 is a block diagram showing the arrangement of the first exemplary embodiment of the present invention;

FIG. 2 is a flowchart showing the operation of the first exemplary embodiment of the present invention;

FIG. 3 is a block diagram showing the arrangement of the second exemplary embodiment of the present invention;

FIG. 4 is a flowchart showing the operation of the second exemplary embodiment of the present invention;

FIG. 5 is a flowchart showing the operation of generating an altered search rule in the operation of the second exemplary embodiment of the present invention;

FIG. 6 is a block diagram showing the arrangement of the third exemplary embodiment of the present invention;

FIG. 7 is a flowchart showing the operation of the third exemplary embodiment of the present invention;

FIG. 8 is a block diagram showing the arrangement of the fourth exemplary embodiment of the present invention;

FIG. 9 is a flowchart showing the operation of the fourth exemplary embodiment of the present invention;

FIG. 10 is a flowchart showing the operation of converting tree structure information in the operation of the fourth exemplary embodiment of the present invention;

FIG. 11 is a block diagram showing the structure of Practical Example 1 of the present invention;

FIG. 12 is a view showing the image of an output UI of Practical Example 1 of the present invention;

FIG. 13 is a view showing the image of tree structure information of the output UI of Practical Example 1 of the present invention;

FIG. 14 is a view showing the image of an input sample of Practical Example 1 of the present invention;

FIG. 15 is a view showing the image of structure definition information of Practical Example 1 of the present invention;

FIG. 16 is a view showing the image of an output UI and its structure definition information of Practical Example 1 of the present invention;

FIG. 17 is a view showing the image of an output UI of Practical Example 1 of the present invention;

FIG. 18 is a view showing the image of an output UI of Practical Example 1 of the present invention;

FIG. 19 is a view showing the image of new structure definition information of Practical Example 1 of the present invention;

FIG. 20 is a view showing the image of the correspondence of structure definition information of Practical Example 1 of the present invention;

FIG. 21 is a block diagram showing the arrangement of Practical Example 2 of the present invention;

FIG. 22 is a view showing the image of an output UI of Practical Example 2 of the present invention;

FIG. 23 is a view showing the image of tree structure information of Practical Example 2 of the present invention;

FIG. 24 is a view showing the image of tree structure information of Practical Example 2 of the present invention; and

FIG. 25 is a block diagram showing the arrangement of still another exemplary embodiment of the present invention.

### BEST MODE FOR CARRYING OUT THE INVENTION

A best mode for carrying out the present invention will be explained in detail below with reference to the accompanying drawings.

### First Exemplary Embodiment

First, the main points of the first exemplary embodiment of a UI recognition device of the present invention will be explained below.

In the first exemplary embodiment of the UI recognition device of the present invention, GUI parts and the relationship (layout) between the parts are extracted from a UI and expressed as tree structure information reflecting the inclusive relationship and positional relationship. A preferred example of the information expressing method is a data model of eXtensible Markup Language (to be referred to as XML hereinafter). When a UI is originally output in the form of HTML or XML from an AP, this document is directly usable.

After that, as a preparation stage before UI recognition, several UI display samples and parts to be specified in the display samples are input to the UI recognition device. By analyzing these display samples and parts, a portion that can change in the tree structure information and the range of the change are presumed. In addition, a fixed portion that originally has the ability to change its contents but does not change at all in practice, e.g., a text display portion among the GUI parts is also presumed. Structure definition information of the tree structure information is formed by using the presumption results. At the same time, search rules for searching for parts to be specified in the display samples are formed by using this structure definition information, such that no contradiction occurs even when the UI has changed. The UI structure definition information and part search rules thus obtained are saved.

When actually recognizing a UI, the UI is first expressed as tree structure information, and parts to be specified are found by applying the search rules to the tree structure information, and output.

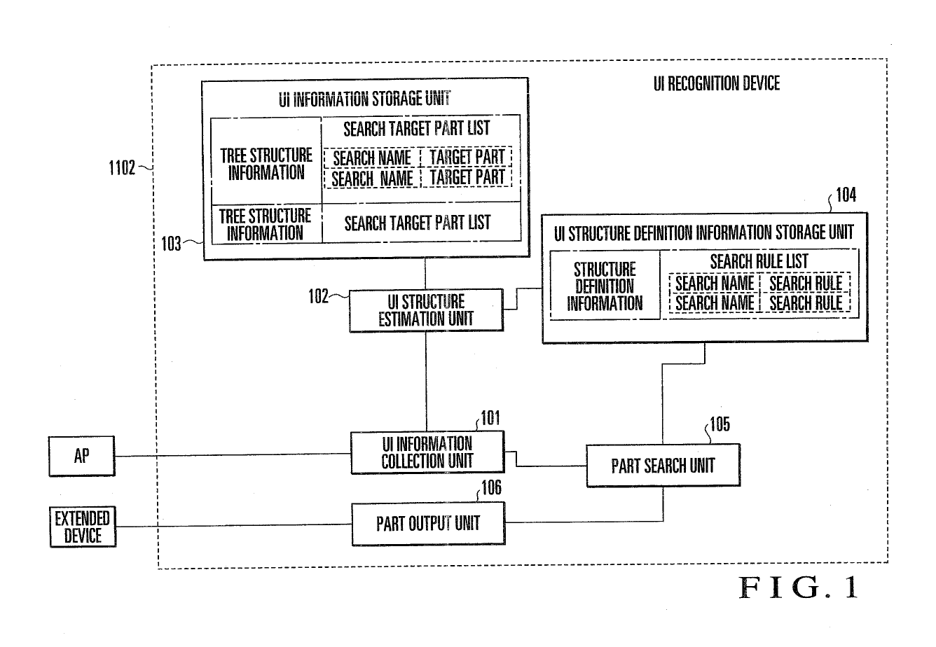

The arrangement of the first exemplary embodiment of the UI recognition device of the present invention will now be explained in detail below with reference to FIG. 1. FIG. 1 is a block diagram showing the arrangement of the first exemplary embodiment of the UI recognition device of the present invention.

Referring to FIG. 1, the first exemplary embodiment of the UI recognition device of the present invention includes a UI information collection unit 101 that acquires information (UI information) concerning a UI output from an AP, and generates tree structure information based on the acquired UI information, a UI information storage unit 103 that records the tree structure information and a search target part list, a UI structure estimation unit 102 that generates structure definition information and a search rule list based on the tree structure information and search target part list stored in the UI information storage unit 103, a UI structure definition information storage unit 104 that stores the generated structure definition information and search rule list, a part search unit 105 that obtains a part of interest by applying a search rule to the tree structure information, and a part output unit 106 that outputs a search name and the search rule application result.

The individual units will be explained below.

The UI information collection unit 101 acquires information (UI information) pertaining to a UI output from an AP. The UI information contains information indicating parts constructing the UI, and information indicating the positional relationship (layout) between these parts. Based on the acquired UI information, the UI information collection unit 101 generates tree structure information expressing the UI as a tree structure. In the preparation stage, the UI information collection unit 101 acquires, as a search target part list, both information (search target part information) indicating a search target part (specification target part) among the parts constructing the UI, and information indicating the search name (identifier) of the part. In the preparation stage, the UI information collection unit 101 outputs the generated tree structure information and search target part list to the UI structure estimation unit 102. On the other hand, in the UI recognition stage, the UI information collection unit 101 outputs the generated tree structure information to the part search unit 105.

The UI structure estimation unit 102 stores the tree structure information and search target part list transferred from the UI information collection unit 101 in the UI information storage unit 103. When structure definition estimation is designated, the UI structure estimation unit 102 generates structure definition information defining the structure of a user interface, based on the tree structure stored in the UI information storage unit 103. The UI structure estimation unit 102 also generates a search rule list based on the generated structure definition information and the tree structure information and search target part list stored in the UI information storage unit 103. The search rule list contains pairs of search names and search rules. The search rule list is formed based on the structure definition information such that no contradiction occurs even when the UI has changed. The UI structure estimation unit 102 outputs the generated structure definition information and search rule list to the UI structure definition information storage unit 104.

The UI structure definition information storage unit 104 stores the structure definition information and search rule list transferred from the UI structure estimation unit 102, and transfers the information and list to the part search unit 105.

The part search unit 105 applies a search rule acquired from the UI structure information storage unit 104 to the tree structure information acquired from the UI information collection unit 101, and outputs a part as the result of the application and the search name of the search rule to the part output unit 106.

The part output unit 106 outputs the set of the search name and search result to an AP extended device requiring the UI recognition.

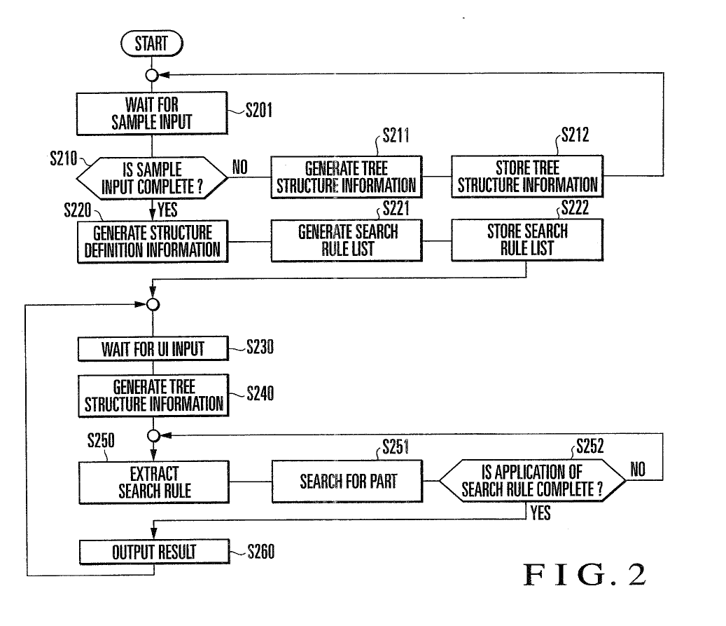

The operation of the first exemplary embodiment of the UI recognition device of the present invention will be explained in detail below with reference to FIG. 2. FIG. 2 is a flowchart showing the operation of the first exemplary embodiment of the UI recognition device of the present invention.

First, in step S201, the UI recognition device waits for the input of a UI display sample (UI information) output from an AP, and information indicating a part (search target part) as a search target among parts constructing the UI and the search name of the part. When these pieces of information are input, the process advances to step S211, and the UI information collection unit 101 generates tree structure information based on the display sample. Also, the UI information collection unit 101 relates the search target part to the search name, and acquires the relation as a search target part list. The UI information collection unit 101 outputs the generated tree structure information and acquired search target part list to the UI structure estimation unit 102. In step S212, the UI structure estimation unit 102 stores the tree structure information and search target part list in the UI information storage unit 103.

If the display sample input is complete in step S210, the process advances to step S220, and the UI structure estimation unit 102 generates structure definition information by using the tree structure information stored in the UI information storage unit 103. In step S221, the UI structure estimation unit 102 generates a search rule list based on the generated structure definition information, tree structure information, and search target part list. In step S222, the UI structure estimation unit 102 stores the search rule list in the UI structure definition information storage unit 104.

In step S230, UI information as a target of recognition is waited for. When UI information is input, the process advances to step S240, and the UI information collection unit 101 generates tree structure based on the UI information, and outputs the tree structure information to the part search unit 105. If there is a search rule in the search rule list, the part search unit 105 extracts the search rule in step S250. In step S251, the part search unit 105 searches for a part by applying the search rule to the tree structure information. The part search unit 105 outputs a set of the found part and its search name to the part output unit 106, and extracts the next search rule.

If all search rules are completely applied in step S252, the process advances to step S260, and the part output unit 106 outputs a list of the search names and the parts as the search results to the extended device. After that, the process returns to step S230 to wait for UI information.

As explained above, the first exemplary embodiment of the UI recognition device of the present invention can specify a UI part corresponding to the change in UI caused by the change in contents of an AP. This is so because the UI recognition device can recognize the change in UI caused by the change in contents as structure definition information, and form a part search rule by using the structure definition information, thereby performing search by taking account of a structural change caused by the change in contents.

### Second Exemplary Embodiment

First, the main points of the second exemplary embodiment of the UI recognition device of the present invention will be explained.

In the second exemplary embodiment of the UI recognition device of the present invention, if the structure of a UI has changed because an application is altered, structure definition information is generated from a display sample of the altered UI as a preparation, in addition to the first exemplary embodiment. Additionally, the difference between pieces of structure information before and after the alteration is calculated, and the position of a part having moved by the alteration is detected. A search rule for the altered UI is generated by using the detection result and a search rule before the alteration, and the altered structure information and search rule are saved.

When actually recognizing a UI, a part to be specified is found by using the altered search rule.

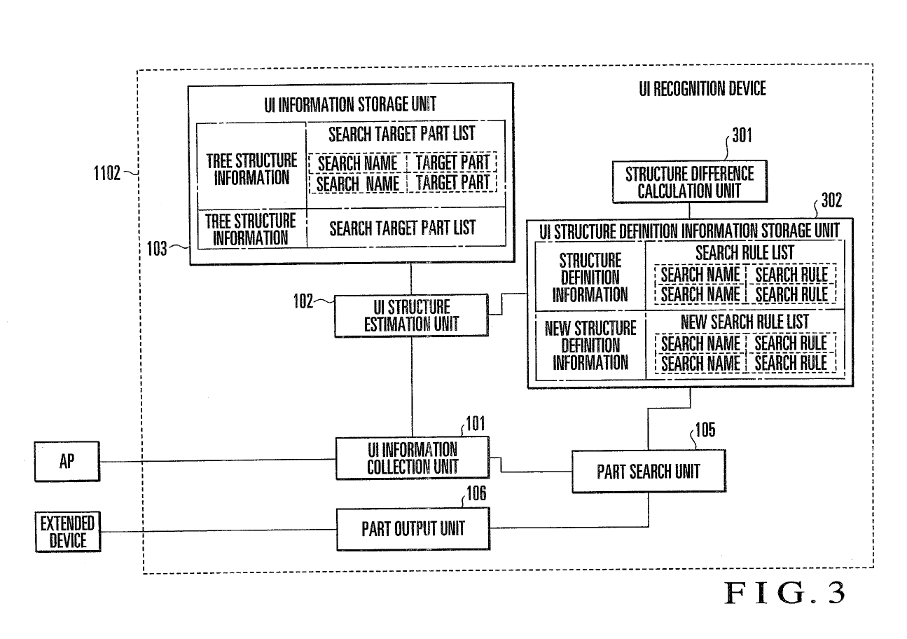

The arrangement of the second exemplary embodiment of the UI recognition device of the present invention will now be explained in detail with reference to FIG. 3. FIG. 3 is a block diagram showing the arrangement of the second exemplary embodiment of the UI recognition device of the present invention. In the following explanation, the same reference numerals as in the first exemplary embodiment denote the same parts, and a repetitive explanation will be omitted.

As shown in FIG. 3, the second exemplary embodiment includes a structure difference calculation unit 301 for calculating the difference between two pieces of structure definition information, in addition to the arrangement of the first exemplary embodiment. Also, a UI structure definition information storage unit 302 has new structure definition information and a new search rule list.

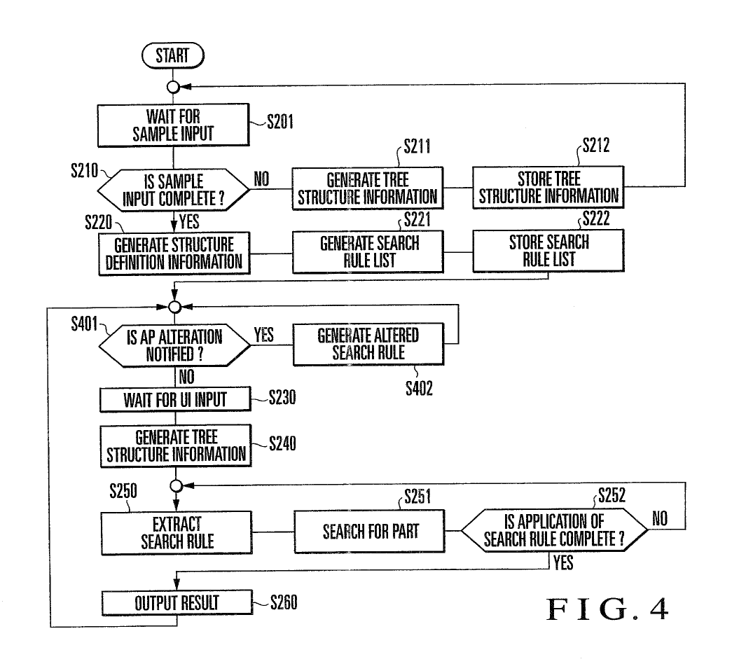

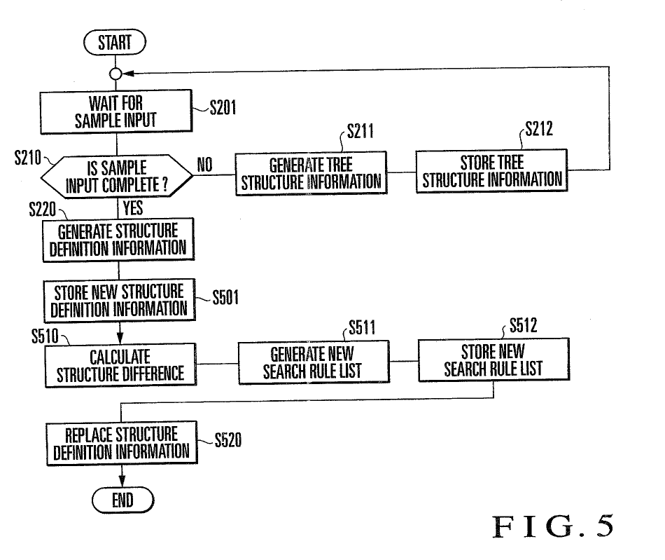

The operation of the second exemplary embodiment of the UI recognition device of the present invention will be explained in detail below with reference to FIGS. 4 and 5. FIGS. 4 and 5 are flowcharts showing the operation of the second exemplary embodiment of the UI recognition device of the present invention. In the following explanation, the same reference numerals as in the first exemplary embodiment denote the same parts, and a repetitive explanation will be omitted.

In the second exemplary embodiment as shown in FIG. 4, whether an AP is altered is determined in step S401 before a UI is input. If the AP is altered, an altered search rule is generated in step S402.

FIG. 5 is a flowchart showing details of the operation of generating an altered search rule in step S402 of FIG. 4. The process of generating structure definition information from an altered UI display sample in steps S201, S210, S211, S212, and S220 is the same as the process before the alteration explained in the above-mentioned first exemplary embodiment. The generated structure definition information after the UI alteration is temporarily stored as new structure definition information in the UI structure definition information storage unit 302.

In step S510, the structure difference calculation unit compares structure definition information (structure definition information before the UI alteration) with the new structure definition information (structure definition information after the UI alteration), thereby checking the correspondence of a part before the alteration to a part after that. In step S511, the structure difference calculation unit generates a new search rule list for extracting a part from the altered UI, based on the correspondence and a search rule list. In step S512, the structure difference calculation unit stores the new search rule list in the UI structure definition information storage unit 302. Finally, in step S520, the structure difference calculation unit respectively copies the newly generated new structure definition information and new search rule list to the structure definition information and search rule list.

Consequently, even when an AP is altered and a UI structure has largely changed, it is possible to continuously recognize the new UI by generating a part search rule corresponding to the new UI.

In the second exemplary embodiment of the UI recognition device of the present invention as explained above, even when an AP itself is altered and the structure of a UI has largely changed, a UI part can be specified in the same manner as that before the alteration by only inputting a display sample. This is so because a rule by which a part designated before the AP alteration is found after that can be constructed by detecting a part correspondence by calculating the difference between the structure definitions of the UI before and after the AP alteration.

### Third Exemplary Embodiment

First, the main points of the third exemplary embodiment of the UI recognition device of the present invention will be explained below.

When actually recognizing a UI in the third exemplary embodiment of the UI recognition device of the present invention, whether tree structure information of the UI and preformed structure definition information contradict each other is verified, in addition to the first exemplary embodiment. If there is no contradiction, part search is normally performed. If the verification is unsuccessful, however, a recognition failure is output without performing any recognition.

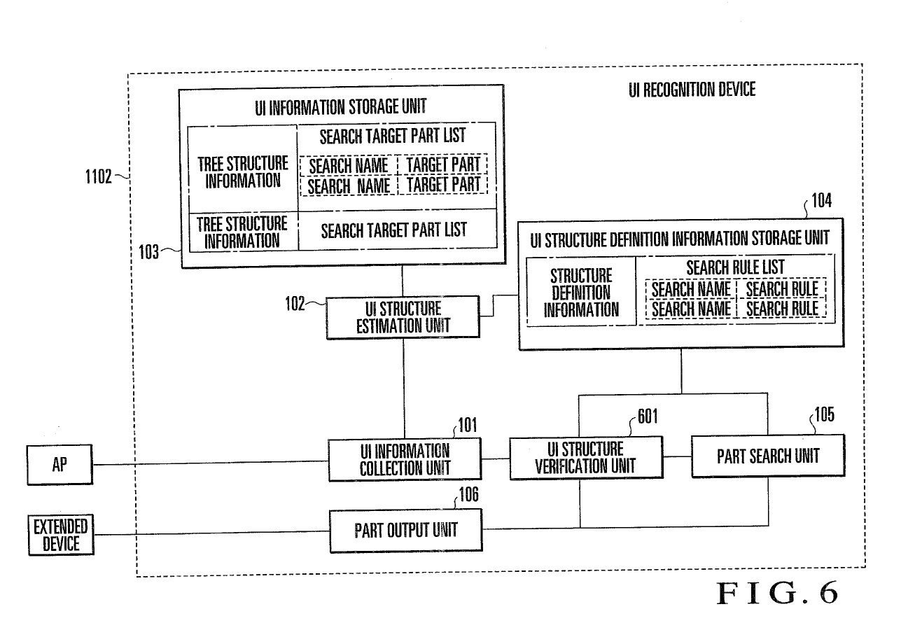

The arrangement of the third exemplary embodiment of the UI recognition device of the present invention will now be explained in detail with reference to FIG. 6. FIG. 6 is a block diagram showing the arrangement of the third exemplary embodiment of the UI recognition device of the present invention. In the following explanation, the same reference numerals as in the first exemplary embodiment denote the same parts, and a repetitive explanation will be omitted.

As shown in FIG. 6, the third exemplary embodiment includes a UI structure verification unit 601 for verifying whether a UI input when performing UI recognition contradicts structure definition information stored in a UI structure definition information storage unit, in addition to the arrangement of the first exemplary embodiment.

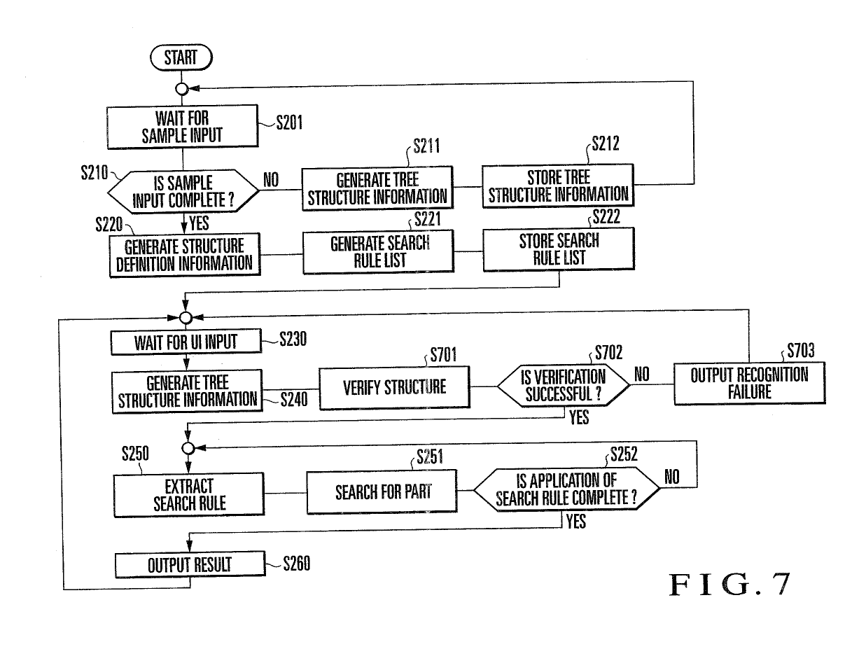

The operation of the third exemplary embodiment of the UI recognition device of the present invention will be explained in detail below with reference to FIG. 7. FIG. 7 is a flowchart showing the operation of the third exemplary embodiment of the UI recognition device of the present invention. In the following explanation, the same reference numerals as in the first exemplary embodiment denote the same parts, and a repetitive explanation will be omitted.

In the third exemplary embodiment as shown in FIG. 7, after tree structure information is generated in step S240, whether the tree structure information contradicts structure definition information is verified in step S701. If the verification is successful in step S702, the application of a search rule is performed from step S250. If the verification is unsuccessful, a recognition failure is output as a result in step S703, and the process waits in step S230 until the next UI is input.

Consequently, if no structure definition can completely be estimated from a UI display sample, it is possible to avoid a part recognition error caused by the application of a search rule based on wrong structure definition estimation.

In the third exemplary embodiment of the UI recognition device of the present invention as explained above, if no structure definition can completely be estimated from a UI display sample, it is possible to avoid a part recognition error caused by the application of a search rule based on wrong structure definition estimation. This is so because whether tree structure information of a UI matches structure definition information created in advance is verified, and this makes it possible to identify whether the structure definition information and a search rule formed from the information are effective on the UI to be recognized.

### Fourth Exemplary Embodiment

First, the main points of the fourth exemplary embodiment of the UI recognition device of the present invention will be explained below.

In addition to the first exemplary embodiment, the fourth exemplary embodiment of the UI recognition device of the present invention has a structure change rule for complicating or simplifying tree structure information of a UI, converts tree structure information of a UI into another tree structure information, and uses the converted tree structure information in the estimation of a structure or the search for a part.

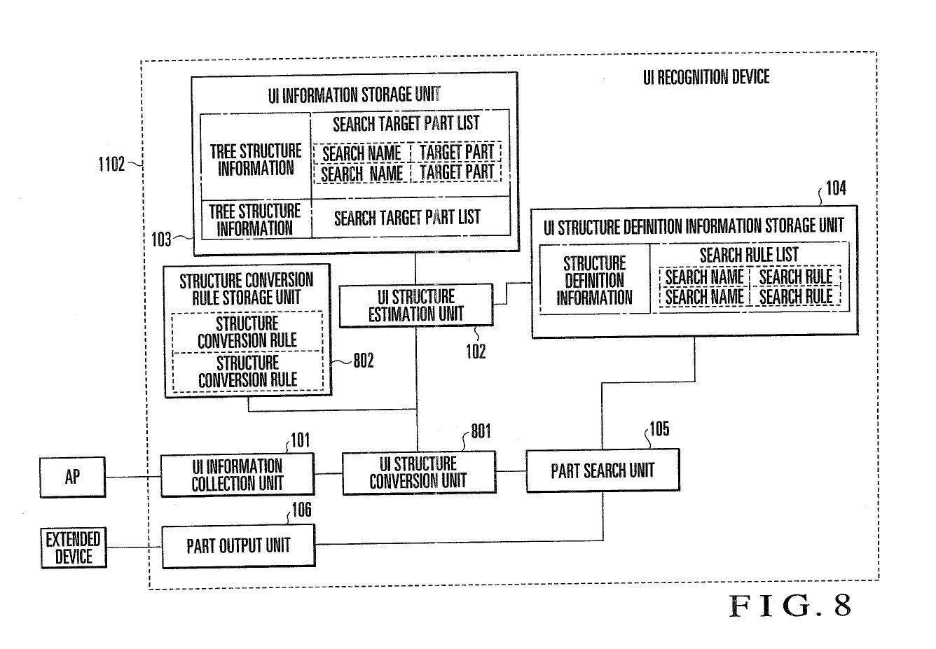

The arrangement of the fourth exemplary embodiment of the UI recognition device of the present invention will now be explained in detail with reference to FIG. 8. FIG. 8 is a block diagram showing the arrangement of the fourth exemplary embodiment of the UI recognition device of the present invention. In the following explanation, the same reference numerals as in the first exemplary embodiment denote the same parts, and a repetitive explanation will be omitted.

As shown in FIG. 8, the fourth exemplary embodiment includes a UI structure conversion unit 801 for converting tree structure information output from a UI information collection unit 101 into another tree structure information, and a structure conversion rule storage unit 802 for storing a structure conversion rule, in addition to the arrangement of the first exemplary embodiment.

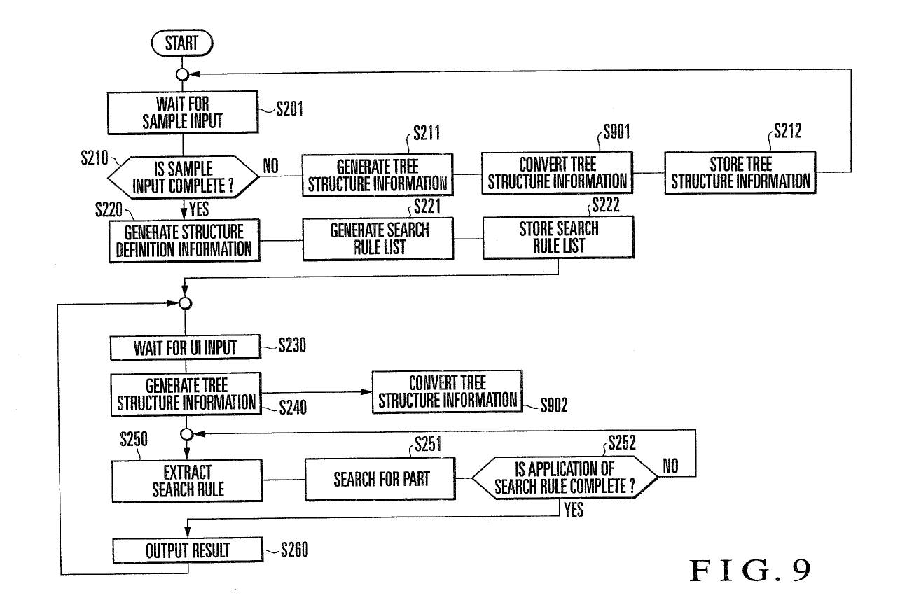

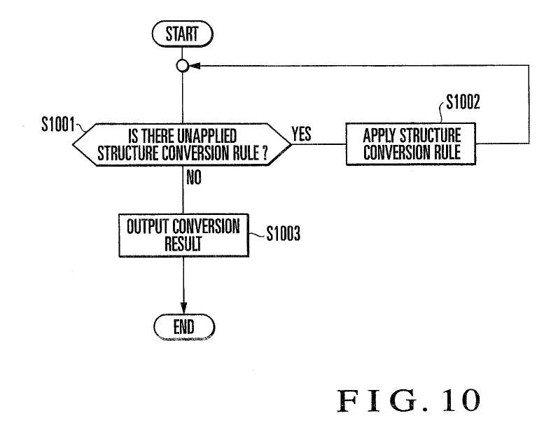

The operation of the fourth exemplary embodiment of the UI recognition device of the present invention will be explained below with reference to FIGS. 9 and 10. FIGS. 9 and 10 are flowcharts showing the operation of the fourth exemplary embodiment of the UI recognition device of the present invention. In the following explanation, the same reference numerals as in the first exemplary embodiment denote the same parts, and a repetitive explanation will be omitted.

In the fourth exemplary embodiment as shown in FIG. 9, after tree structure information is generated in each of steps S211 and S240, a tree structure information conversion process is performed in steps S901 and S902, and the result of the conversion is used in the estimation of structure definition or in search.

FIG. 10 is a flowchart showing details of the operation of the tree structure information conversion process in steps S901 and S902 shown in FIG. 9. In step S1001, the UI structure conversion unit 801 checks the structure conversion rules stored in the structure conversion rule storage unit 802. If there are unapplied structure conversion rules, the UI structure conversion unit 801 performs conversion by sequentially applying the rules in step S1002. The second and subsequent rules are each applied to the result of the application of an immediately preceding conversion rule. If all the structure conversion rules have been applied, the results are output in step S1003.

Consequently, if structure information such as HTML or a tag does not appropriately express the meaning of the contents or if only a flat structure can be seen because no structure information is contained in UI information acquired from an AP directly using GUI parts of an operating system (to be referred to as an OS hereinafter), a heuristic rule for discriminating a typical UI generation rule is prepared and applied. This facilitates estimating structure definition or searching for a part.

In the fourth exemplary embodiment of the UI recognition device of the present invention as explained above, if structure information such as HTML or a tag does not appropriately express the meaning of the contents or if only a flat structure can be seen because no structure information is contained in UI information acquired from an AP directly using GUI parts of an OS, a heuristic rule for discriminating a typical UI generation rule is prepared and applied. This facilitates estimating structure definition or searching for a part. This is so because it is possible to save and apply a rule for converting the tree structure information of a UI.

Although the first to fourth exemplary embodiments of the present invention have been explained above, it is also possible to freely combine these exemplary embodiments.

Next, practical examples using the UI recognition device of the present invention will be explained below. As the practical examples, information extracting apparatuses using the UI recognition device of the present invention will be explained.

### Practical Example 1

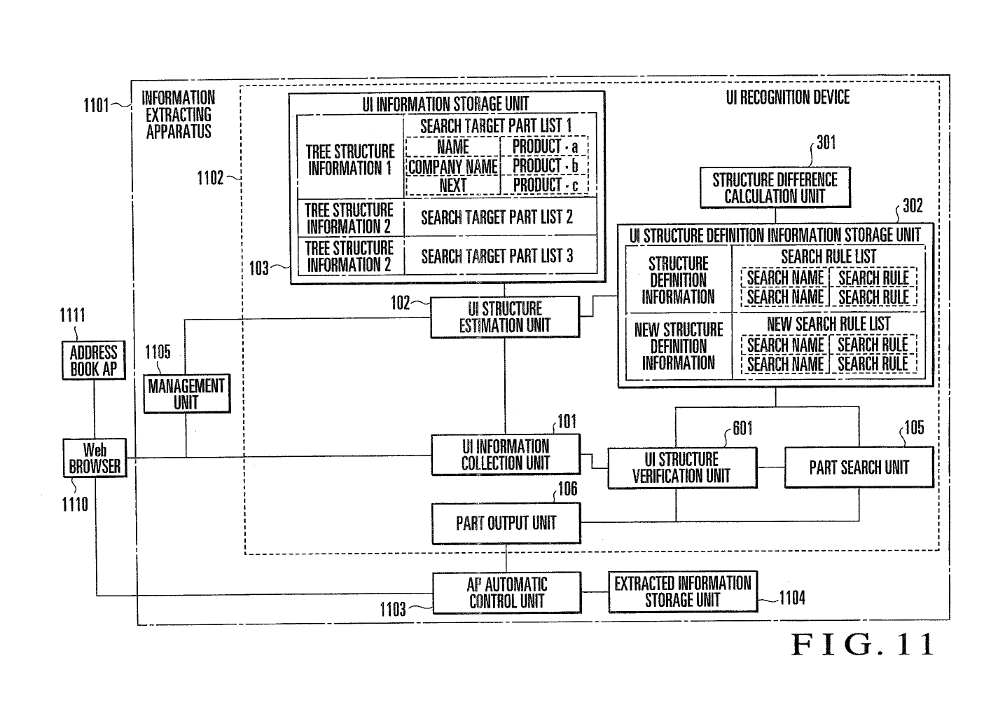

FIG. 11 is a view showing the arrangement of the information extracting apparatus using the UI recognition device of the present invention.

An information extracting apparatus 1101 includes a UI recognition device 1102 of the present invention, an automatic control unit 1103, an extracted information storage unit 1104, and a management unit 1105. A UI information collection unit 101 and the AP automatic control unit 1103 are connected to a Web browser 1110. The Web browser is connected to an address book AP 1111 as a WWW application storing a plurality of pieces of personal address information.

The address book AP 1111 outputs HTML as a UI.

The browser inputs, to the UI information collection unit, parts and layout information of the UI in the form of HTML already analyzed as a document object model (to be referred to as a DOM hereinafter) by the browser. This DOM form is directly used as the form of tree structure information.

A search rule for searching for a part is expressed as an XML path language (to be referred to as an XPath hereinafter).

Structure definition information is expressed in a form in which nodes such as elements and attributes appearing in HTML are classified into a node that always fixedly appears, a node that changes its value every time, and a node that changes the number of times of appearance.

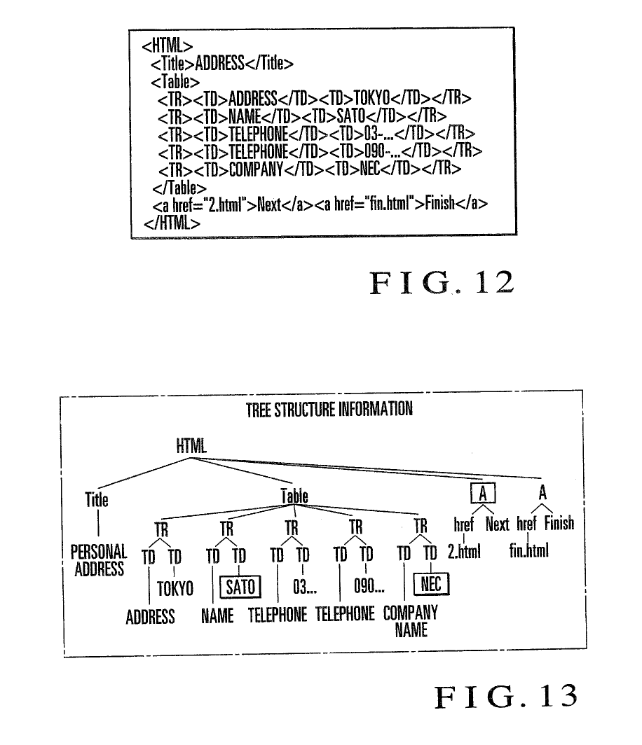

FIG. 12 is a view showing the image of HTML as the UI output to the browser by the address book AP 1111. Note that FIG. 12 is simplified for the sake of explanation and is not a correct HTML, but it can readily be understood that this has no effect on the present invention.

The address book AP 1111 displays address information by the UI as shown in FIG. 12, and displays information of the next person when a link “Next” is clicked. The address information contains the address, name, telephone number, and company name, and can have any arbitrary number of telephone numbers.

FIG. 13 is a view showing the image of the DOM form expression of HTML shown in FIG. 12.

The information extracting apparatus 1101 displays the stored address information one after another by automatically clicking the link “Next” by using the AP automatic control unit 1103. Also, the information extracting apparatus 1101 extracts information of the name and company name, and stores the information in the extracted information storage unit 1104.

To achieve this processing, the automatic control device must specify, as UI parts, a link (<A> tag) corresponding to “Next”, and element value nodes (nodes surrounded by rectangles in FIG. 13) describing the values of the name and company name.

### Operation Example 1

An example of the operation of the information extracting apparatus using the UI recognition device of the present invention will be explained below.

First, as preparations, the management unit 1105 displays a sample of a UI on the Web browser, and inputs the sample screen, parts to be specified on the screen, and the search names of the parts to the UI information collection unit 101.

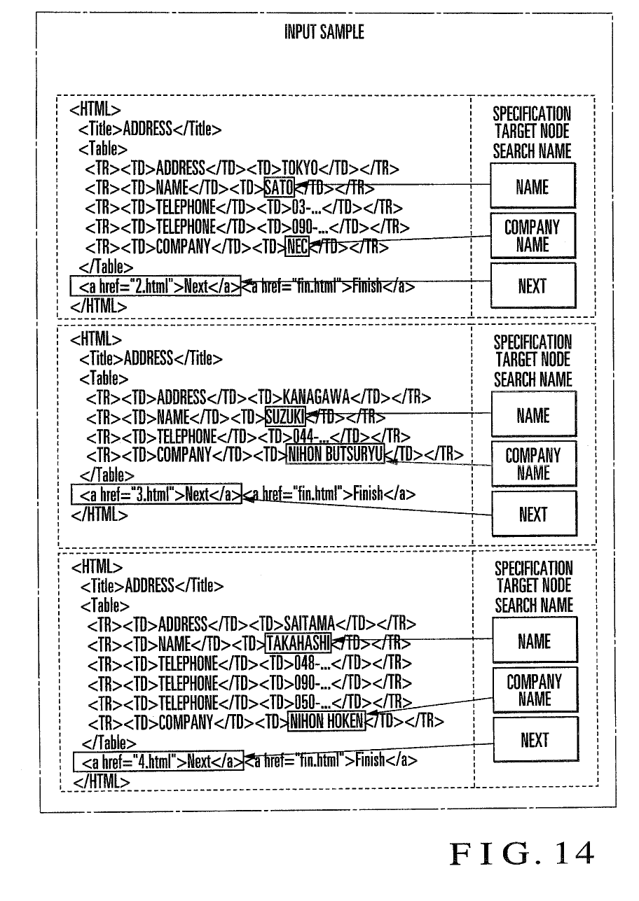

FIG. 14 shows three display samples to be input, three parts to be specified in each of the display samples, and the search names of the parts.

The search names are “NAME” as the name, “COMPANY NAME” as the name of a company, and “NEXT” as the link of Next.

First, a UI structure estimation unit 102 converts the DOM expression of the input HTML into tree structure information. In this example, however, the UI structure estimation unit 102 directly outputs the DOM expression because the DOM expression is already tree structure information.

Then, the UI structure estimation unit 102 stores pieces of tree structure information 1, 2, and 3 of the display samples and information of search target part lists 1, 2, and 3 in a UI information storage unit 103.

When the three samples are completely input, the management unit 1105 notifies the UI structure estimation unit 102 of the completion of the sample input.

When notified, the UI structure estimation unit 102 first analyzes the pieces of tree structure information 1, 2, and 3 stored in the UI information storage unit 103, and estimates a node that always fixedly appears, a node that changes its value every time, and a node that changes the number of times of appearance.

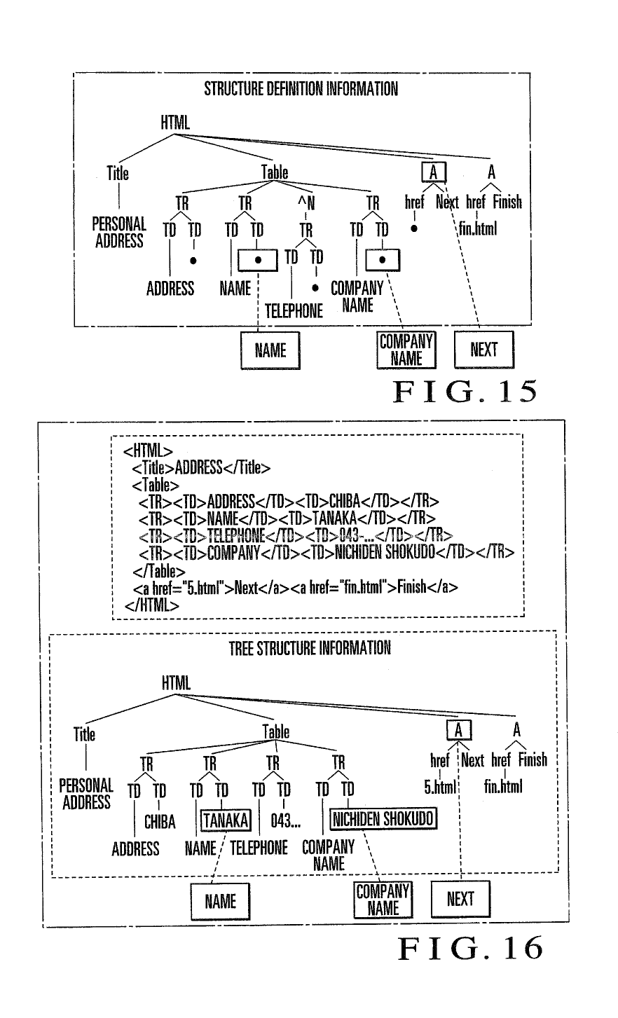

FIG. 15 is a view showing the image of structure definition information obtained by the analysis. A portion where a tag name or element value appearing in HTML is directly described indicates the node that fixedly appears. A portion where ‘*’ is described indicates the node that changes its value every time. A portion where ‘̂N’ is described indicates the node that changes the number of times of appearance.

Subsequently, the UI structure estimation unit 102 checks a target to be searched for in the structure definition information by using a search target part list. In this example, nodes surrounded by rectangles in FIG. 15 are the search target nodes and their search names. Therefore, the UI structure estimation unit 102 then generates an XPath expression for specifying these search target nodes.

Generally, it is possible to derive a plurality of XPath search expressions for designating a specific node in certain tree structure information.

Although a method of deriving the XPath expression is not particularly defined in the present invention, Practical Example 1 derives the expression by using the following three rules.

[Rule 1]

A path extending from the root of tree structure information to a node of interest is designated together with the position between brother nodes.

For example, an XPath expression for designating the node of an ‘A’ tag corresponding to “NEXT” in FIG. 15 can be described as “/HTML/A[1]”. This means a tag appearing second among A tags of HTML tags.

[Rule 2]

Of child nodes of a node of interest, the existence of a node by which the node of interest can uniquely be specified is designated as a condition.

For example, an XPath expression for designating the node of an ‘A’ tag corresponding to “NEXT” in FIG. 15 can be described as “//A[[.1text( )=Next]”. This means an ‘A’ tag having ‘Next’ as an element value among ‘A’ tags appearing in arbitrary places.

[Rule 3]

Of nodes having the same ancestor as that of a node of interest, the existence of a node by which the node of interest can uniquely be specified is designated as a condition.

For example, an XPath expression for designating a node having an element value corresponding to “NAME” in FIG. 15 can be described as “//text( )[ . . . / . . . /TD[1]/text( )=Name]”. This means that, of element values appearing in arbitrary places, the element value of a TD tag appearing first among grandparent nodes (TR tags) is ‘Name’.

It is not always possible to derive all these rules. For example, a node corresponding to “COMPANY NAME” cannot be expressed as “/HTML/Table/TR[4]/TD/text( )” by using (1). This is so because the position between TR tag brothers changes in accordance with the number of telephone numbers, and is not necessarily the fourth.

Accordingly, the UI structure estimation unit 102 tries to derive XPaths by using these rules, and adopts, as a search expression, one XPath by which a target node can correctly uniquely be specified. Consequently, the search expressions of ‘NAME’, ‘COMPANY NAME’, and ‘NEXT’ are respectively “/HTML/Table/TR[2]/TD[2]/text( )”, “//text( )[ . . . / . . . /TD[1]/text( )=Company Name]”, and “/HTML/A[1]”.

The UI structure estimation unit 102 stores the above-mentioned structure information and the list of the search names and XPath expressions in the structure definition information and search rule list, respectively, of the UI structure definition information storage unit 302.

Then, actual UI recognition is performed.

When the address book AP 1111 outputs HTML shown in FIG. 16, the UI information collection unit 101 acquires the DOM expression of the HTML from the Web browser 1110, and transfers the DOM expression to a UI structure verification unit 601.

The UI structure verification unit 601 compares the transferred HTML DOM expression with the structure definition information stored in a UI structure definition information storage unit 302, and checks whether there is a contradiction. Since there is no problem, the UI structure verification unit 601 transfers the HTML DOM expression to a part search unit 105.

The part search unit 105 extracts the search rule list stored in the UI structure definition information storage unit 302, specifies nodes corresponding to ‘NAME’, ‘COMPANY NAME’, and ‘NEXT’ by applying the three XPath expressions as search rules, and notifies the AP automatic control unit 1103 of the search names and corresponding nodes via a part output unit 106.

The AP automatic control unit 1103 stores element values corresponding to ‘NAME’ and ‘COMPANY NAME’ in the extracted information storage unit 1104, and sends, to the Web browser, an event in which the link corresponding to ‘NEXT’ is clicked, thereby storing the next page.

### Operation Example 2

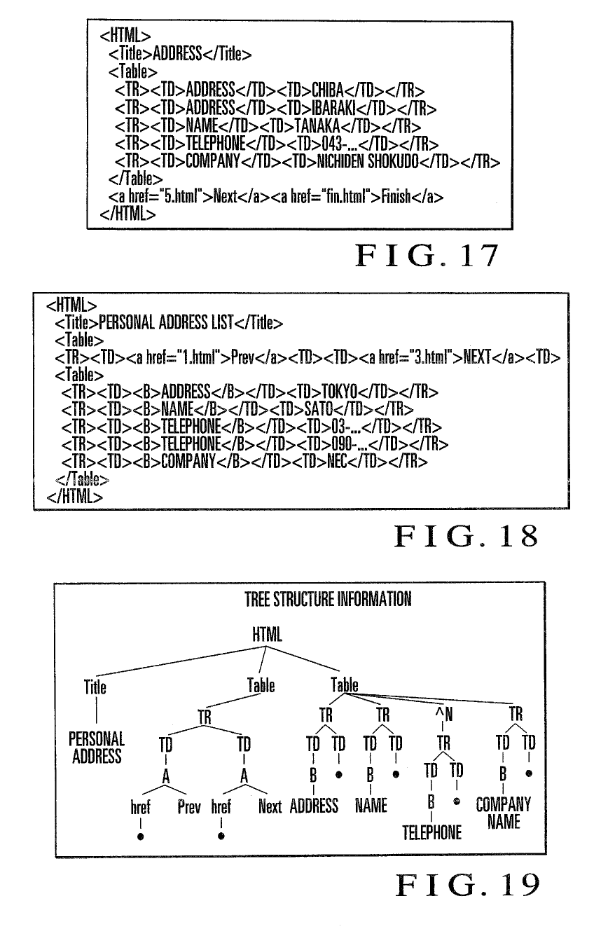

An operation when HTML including two addresses not existing in the sample shown in FIG. 17 is output will be explained below.

In this case, the processing is the same as that of the example shown in FIG. 16 up to the operation of the UI information collection unit, but verification is unsuccessful because the UI structure verification unit 601 finds, by comparison, the contradiction that the HTML has two addresses.

As a consequence, the AP automatic control unit 1103 is notified that the recognition is unsuccessful, and the information extracting process is interrupted.

If a search expression is applied without performing any verification, a character string ‘IBARAKI’ that is originally an address corresponds to the name portion, so a wrong result is extracted.

If an interruption like this occurs, the user of the information extracting apparatus can remake correct search rules by giving a sample including FIG. 17 as well.

### Operation Example 3

An operation when the address book AP 1111 is altered and a UI to be output changes as shown in FIG. 18 will be explained below.

After this alteration, address information itself to be managed remains unchanged, but the title, the position of the Next button, the thick characters of item names, and the like are changed.

In this case, several DOM structures of samples of the new UI are input first, and structure definition information of the new UI is stored as new structure definition information in the UI structure definition storage unit 302. Methods of generating the samples and new structure definition information are similar to the methods described previously, so a repetitive explanation will be omitted. No search target list is input.

FIG. 19 is a view showing the image of the generated new structure definition information.

Then, the original structure definition information (FIG. 15) and new structure definition information (FIG. 19) are compared, and the node correspondence is calculated as a difference calculation.

As a method of the difference calculation, it is possible to use an XML difference calculation method by which the similarity of nodes contained in the two pieces of information is calculated, and that node of the new structure definition information which is most similar to a node of the original structure definition information is regarded as a corresponding node.

In Practical Example 1, the similarity is calculated for combinations of all new and old nodes based on the references that nodes themselves are the same (the tag names, element values, or the like are the same), descendant nodes of the nodes are similar, and ancestor nodes of the nodes are similar.

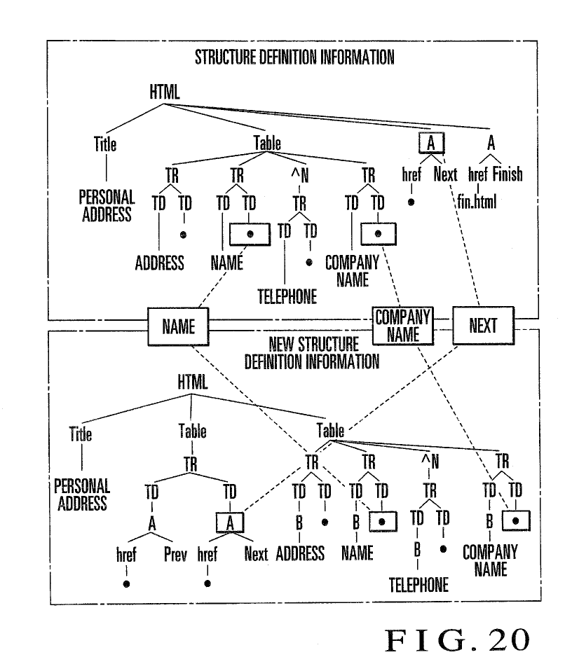

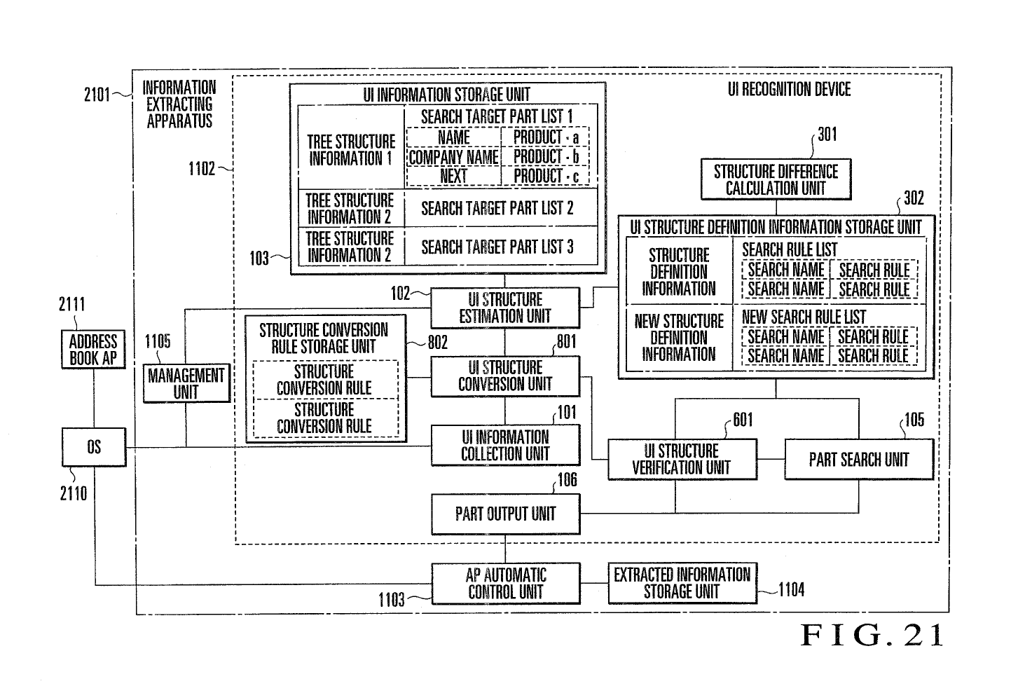

Consequently, those nodes of the new structure definition information which correspond to nodes as search targets in the original structure definition information can be calculated as shown in FIG. 20.

This makes it possible to specify a node to be searched for in the new structure definition information with respect to each search name. Therefore, an XPath expression for specifying each target node is then generated. This generation method is the same as that described above.

As a consequence, the search expressions of ‘NAME’, ‘COMPANY NAME’, and ‘NEXT’ in the altered UI are respectively “/HTML/Table[2]/TR[2]/TD[2]/text( )”, “//text( )[ . . . / . . . /TD[1]/B/text( )=Company Name]”, and “/HTML/Table[1]/TR/TD[2]/A[1]”. These search expressions are stored as a new search rule list in the UI structure definition information storage unit 302.

Finally, the contents of the derived new structure definition information and new search expression rule list are respectively set in the structure definition information and search rule list, and the new search expressions are used in recognition after that.

### Practical Example 2

Practical Example 2 is the same as Practical Example 1 described above in that the UI recognition device of the present invention is used in an information extracting apparatus, except that the apparatus further includes a UI structure conversion unit 801 and structure conversion rule 802.

Also, in Practical Example 2, an address book AP 2111 generates a UI using not HTML but GUI parts of an OS, and a UI information collection unit is connected to an OS 2110 and obtains, via the OS, a list for referring to the GUI parts and layout information of the GUI parts on the screen.

A structure conversion rule storage unit stores the following two structure conversion rules.

[Rule 1]

When there are parts juxtaposed at the same level on the screen, it is assumed that a row container part including these parts exists, and a row container node is added as a parent node.

[Rule 2]

When there are parts vertically aligned with the same width on the screen, it is assumed that a column container part containing these parts exists, and a column container node is added as a parent node.

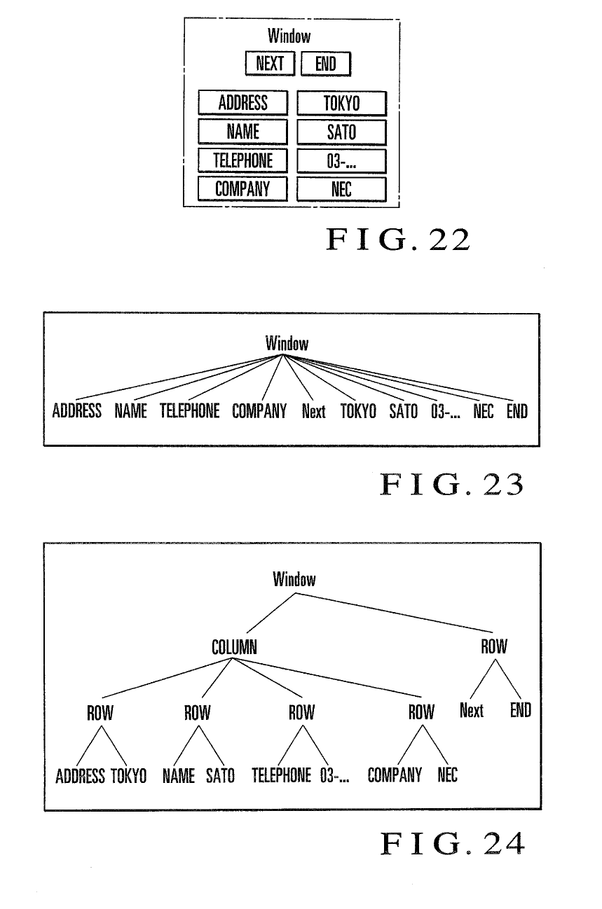

FIG. 22 is a view showing the image of a UI output by the address book AP 2111.

In a window, button parts of Next and END and text parts such as ADDRESS, NAME, TELEPHONE, COMPANY, TOKYO, SATO, 03- . . . , and NEC are arranged.

There is neither an inclusive relationship nor a parent-child relationship between the parts.

FIG. 23 is a view showing the image of tree structure information output from a UI information collection unit. In Practical Example 2, the parts are arranged such that a part on the leftmost side is positioned at the start of the brother relationship between the parts.

In this tree structure information, the relationship between the parts is a simple longitudinal relationship. This makes it difficult to estimate structure information and derive an XPath expression capable of uniquely specifying a search target part.

When the tree structure information shown in FIG. 23 is transferred to the UI structure conversion unit 801, the UI structure conversion unit 801 applies the two structure conversion rules stored in the structure conversion rule storage unit 802, and outputs tree structure information shown in FIG. 24. This tree structure information has a structure close to that of the HTML used in the explanation of Practical Example 1, and can drive an XPath expression capable of uniquely specifying a search target part. Accordingly, the tree structure information output from the UI structure conversion unit 801 is used to calculate structure definition information and apply search expressions, instead of the tree structure information output from the UI structure collection unit. This makes it possible to correctly search for a target part even in a UI having a simple relationship between parts.

In many UIs, parts are not arranged at random but arranged by combining typical layout patterns so that humans can readily understand the layout. Therefore, the effect as described in Practical Example 2 can be obtained by preparing a structure conversion rule that finds a typical part layout pattern as described above, and adds a container node expressing the pattern as a parent node of the parts forming the pattern.

Although the exemplary embodiments and their practical examples of the present invention have been explained above, the present invention is not limited to the above explanation and can variously be modified without departing from the spirit and scope of the invention.

For example, the above-mentioned control operations can also be executed by hardware, software, or a composite configuration of the both.

When executing the processing by using software, a program recording the process sequence can be executed by installing the program in an internal memory of a computer incorporated into dedicated hardware, or by installing the program in a general-purpose computer capable of executing various processes.

For example, the program can be prerecorded in a hard disk or ROM (Read Only Memory) as a recording medium. Alternatively, the program can temporarily or permanently be stored (recorded) in a removable recording medium such as a CD-ROM (Compact Disc Read Only Memory), MO (Magneto Optical) disc, DVD (Digital Versatile Disc), magnetic disc, or semiconductor memory.

These removable recording media can be provided as so-called package software.

Note that the program can be installed in a computer from the removable recording medium as described above, and can also be wirelessly transferred from a download site to a computer, or transferred to a computer by wired communication across a LAN (Local Area Network) or the Internet, and the computer can receive the transferred program and install it in a recording medium such as a built-in hard disc.

Furthermore, although the processes can be executed in a time series manner in accordance with the above-described control operations, the processes can also be executed in parallel or individually as needed or in accordance with the throughput of a device that executes the processes.

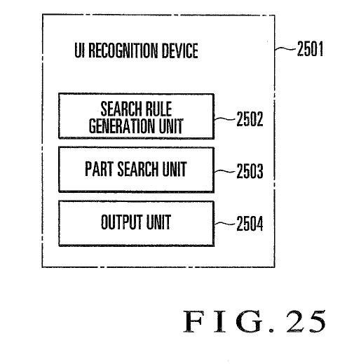

Note that as shown in FIG. 25, a UI recognition device 2501 as an exemplary embodiment of the present invention need only include at least a search rule generation unit 2502, part search unit 2503, and output unit 2504.

The search rule generation unit 2502 has a function of generating a search rule for searching for a search target part among parts forming a UI, based on UI information indicating the parts forming the UI and the positional relationship between the parts, search target part information indicating the search target part among the parts, and structure definition information defining the structure of the UI. The search rule generation unit 2502 may also have the functions of the UI information collection unit 101, UI structure estimation unit 102, UI information storage unit 103, and UI structure definition information storage unit 104 shown in FIG. 1.

When new UI information is input, the part search unit 2503 searches for the search target part from parts indicated by the new UI information by using a search rule generated by the search rule generation unit 2501. The part search unit 2503 may also have the function of the part search unit 105 shown in FIG. 1.

The output unit 2504 outputs the search result from the part search unit 2503. The output unit 2504 may also have the function of the part output unit 106 shown in FIG. 1.

### INDUSTRIAL APPLICABILITY

The present invention is applicable to recognize a UI output from an AP, and, e.g., automatically control the AP or extract information through the UI, allow the user to operate the UI, or conduct an automatic test on the UI.

This application is based upon and claims the benefit of priority from Japanese Patent Application No. 2007-302209, filed Nov. 21, 2007, the entire contents of which are incorporated herein by reference.

1. A user interface recognition device comprising:
a search rule generation unit which generates a search rule for searching for a search target part among parts forming a user interface, based on user interface information indicating the parts forming the user interface and a positional relationship between the parts, search target part information indicating the search target part among the parts, and structure definition information defining a structure of the user interface;
a part search unit which, when new user interface information is input, searches for the search target part among parts indicated by the new user interface information by using the search rule pregenerated by said search rule generation unit; and
an output unit which outputs a search result from said part search unit.

2. A user interface recognition device according to claim 1, wherein said search rule generation unit comprises:
an information collection unit including a function of acquiring the user interface information and generating tree structure information based on the user interface information, and a function of acquiring the search target part information;
a structure estimation unit including a function of generating the structure definition information based on the tree structure information generated by said information collection unit, and a function of generating the search rule based on the tree structure information, the structure definition information, and the search target part information; and
a structure definition information storage unit which stores the structure definition information generated by said structure estimation unit and the search rule.

3. A user interface recognition device according to claim 2, wherein when said information collection unit acquires the new user interface information,
said information collection unit generates new tree structure information based on the new user interface information, and
said part search unit searches for the search target part from the new tree structure information by using the search rule stored in said structure definition information storage unit.

4. A user interface recognition device according to claim 2, further comprising a structure difference calculation unit which calculates a correspondence between two pieces of structure definition information,
wherein when the structure of the user interface is altered,
said structure estimation unit generates structure definition information of the altered user interface, and
said structure difference calculation unit calculates a correspondence between the structure definition information stored in said structure definition information storage unit, and the structure definition information of the altered user interface newly generated by said structure estimation unit, and generates a new search rule for searching for the search target part from the altered user interface.

5. A user interface recognition device according to claim 3, further comprising a structure verification unit which compares the new tree structure information generated by said information collection unit with the structure definition information stored in said structure definition information storage unit, and verifies whether the structures indicated by the two pieces of information have a contradiction,
wherein said structure verification unit performs verification before said part search unit performs search.

6. A user interface recognition device according to claim 2, further comprising:
a structure conversion unit which converts the tree structure information output from said information collection unit into another tree structure information in accordance with a conversion rule; and
a structure conversion rule storage unit which stores a conversion rule to be used by said structure conversion unit,
wherein at least one of said structure estimation unit and said part search unit uses the other tree structure information converted by said structure conversion unit.

7. A user interface recognition method comprising the steps of:
generating a search rule for searching for a search target part among parts forming a user interface, based on user interface information indicating the parts forming the user interface and a positional relationship between the parts, search target part information indicating the search target part among the parts, and structure definition information defining a structure of the user interface;
searching for, when new user interface information is input, the search target part among parts indicated by the new user interface information by using the pregenerated search rule; and
outputting a search result.

8. A user interface recognition method according to claim 7, wherein the step of generating the search rule comprises the steps of:
acquiring the user interface information;
generating tree structure information based on the user interface information;
acquiring the search target part information;
generating the structure definition information based on the tree structure information;
generating the search rule based on the tree structure information, the structure definition information, and the search target part information; and
storing the structure definition information and the search rule.

9. A user interface recognition method according to claim 8, further comprising the steps of:
acquiring the new user interface information; and
generating new tree structure information based on the new user interface information,
wherein the step of searching comprises the step of applying the stored search rule to the new tree structure information.

10. A user interface recognition method according to claim 8, further comprising the steps of:
generating, when the structure of the user interface is altered, structure definition information of the altered user interface;
calculating a correspondence between the stored structure definition information and the structure definition information of the altered user interface; and
generating a new search rule for searching for the search target part from the altered user interface by using a calculation result of the correspondence.

11. A user interface recognition method according to claim 9, further comprising, before the step of searching, the step of comparing the new tree structure information with the stored structure definition information, and verifying whether the structures indicated by the two pieces of information have a contradiction.

12. A user interface recognition method according to claim 8, further comprising the step of converting the tree structure information into another tree structure information by using a conversion rule,
wherein at least one of the step of generating the structure definition information, the step of generating the search rule, and the step of searching uses the other tree structure information.

13. (canceled)

14. (canceled)

15. (canceled)

16. (canceled)

17. (canceled)

18. (canceled)

19. A user interface recognition device comprising:
a search rule generation unit which generates a search rule for searching for a search target part among parts forming a user interface, based on user interface information indicating the parts forming the user interface and a positional relationship between the parts, search target part information indicating the search target part among the parts, and structure definition information defining a structure of the user interface,
said search rule generation unit comprising:
an information collection unit including a function of acquiring the user interface information and generating tree structure information based on the user interface information, and a function of acquiring the search target part information;
a structure estimation unit including a function of generating the structure definition information based on the tree structure information generated by said information collection unit, and a function of generating the search rule based on the tree structure information, the structure definition information, and the search target part information; and
a structure definition information storage unit which stores the structure definition information generated by said structure estimation unit and the search rule.

20. A user interface recognition device according to claim 19, further comprising a structure difference calculation unit which calculates a correspondence between two pieces of structure definition information,
wherein when the structure of the user interface is altered,
said structure estimation unit generates structure definition information of the altered user interface, and
said structure difference calculation unit calculates a correspondence between the structure definition information stored in said structure definition information storage unit, and the structure definition information of the altered user interface newly generated by said structure estimation unit, and generates a new search rule for searching for the search target part from the altered user interface.
